(19) United States
(12) Patent Application Publication
(10) Pub. No.: US 2009/0184024 A1
(43) Pub. Date: Jul. 23, 2009

(54) MEDICATION AND SUPPLEMENT ORGANIZER

(76) Inventor: Debora Hankinson, Golden, CO (US)

Correspondence Address: HENSLEY KIM & HOLZER, LLC, 1660 LINCOLN STREET, SUITE 3000, DENVER, CO, 80264, US

(21) Appl. No.: 12/016,658

(22) Filed: Jan. 18, 2008

(51) Int. Cl. B65D 83/04; A61J 1/03; B65D 25/28

(52) U.S. Cl. 206/534; 206/538; 220/752

(57) ABSTRACT

Technology is described herein for providing a multi-compartmental medication and supplement organizer that can be rolled or folded and “dissected” as needed so that an individual may take needed medications along when traveling while leaving unneeded medications behind. The multi-compartmental medication and supplement organizer allows for carrying medications needed for an extended period of time in an organized yet compact manner, while giving the option of easily carrying specific portions, regimens or subsets of the medication as desired.

### BACKGROUND

Many individuals take a number of medications and/or supplements on a daily basis. The task of organizing and tracking the daily doses is often daunting, particularly for the elderly. The task can also be made more difficult by the fact that some medications and/or supplements must be taken, for example, one time per day, while other medications and/or supplements must be taken two, three or more times per day. It is often difficult to remember how many and what kind of medication needs to be taken, and depending on the medication, it can be dangerous to a person's health if a dosage is missed or is accidentally exceeded.

It is one thing to organize and track various medications and supplements at home; however, organization can be lost when a person works during the day, travels, or is otherwise away from his or her medications. Additionally, many people see more than one doctor, each of which may prescribe medications. In order to protect against drug interaction, a doctor must know what other medications a patient is taking. Often, patients may not remember accurately the types and dosages of the other drugs they are taking, and it would be beneficial to be able to show each physician what drugs are being taken, the dosage of each drug, and the number of doses of each medication or supplement taken per day.

There are a number of medication and pill organizers known in the art. However, with most organizers, a user must carry the entire organizer with them, which can be bulky or inconvenient, or not use the organizer during a certain period of time. Thus, there exists a need for a multi-compartmental medication container that allows a user to organize and transport medications, as well as select a subset of medications to be carried at the convenience of the user.

### SUMMARY

Embodiments described and claimed herein address the foregoing and other situations by providing a novel multi-compartmental medication and supplement organizer that has the advantages of organizers in the prior art but none of the disadvantages. Implementations of the claimed invention provide multi-compartmental medication organizers that permit an individual to carry medications needed for an extended period of time in an organized and compact manner, yet provide the individual the option of easily carrying specific portions, regimens or subsets of the medication as desired.

Thus, in one implementation, there is provided a multi-compartmental medication organizer comprising a substantially planar body constructed of a flexible material; and a plurality of compartment holders detachably attached to a facing side of the body, where each compartment holder comprises a plurality of compartments large enough to hold several pills or supplements. In some aspects of the multi-compartmental medication organizer, the plurality of compartments are detachably attached to the compartment holders by one or more Velcro®-type fasteners, snaps, hooks, magnets, Zilploc®-type fasteners buttons or ties. In other aspects of the multi-compartmental medication organizer, the compartment holders are attached to the body by one or more Velcro®-type fasteners, snaps, hooks, magnets, buttons or ties. In yet other aspects, the multi-compartmental medication organizer further comprises a handle. In addition, other aspects of the multi-compartmental medication organizer provide a fastener capable of securing the multi-compartmental medication organizer in a collapsed configuration, where the fastener may comprise one or more Velcro®-type fasteners, zippers, snaps, hooks, magnets, buttons or ties. In yet other aspects of the multi-compartmental medication organizer, the compartments comprise fasteners used to close the compartments, and may also comprise a flap. Also, in some aspects, the compartments are pleated and an opening of the compartments comprises elastic. The multi-compartmental medication organizers may be in any of a variety of configurations, for example, the multi-compartmental medication organizer may comprise four compartment holders wherein each compartment holder comprises seven compartments, or seven compartment holders wherein each compartment holder comprises four compartments. In some aspects, the body, compartment holders and compartments of the multi-compartmental medication organizer comprise fabric, such as muslin, cotton, silk, wool, polyester, nylon, acrylic, polyurethane, olefin, other polymers or blends thereof. In some aspects, the multi-compartmental medication organizer is washable, and in other aspects, the multi-compartmental medication organizer is waterproof. In yet other aspects, the multi-compartmental medication organizers may comprise a programmable alarm or other system to remind a user to take their medication.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter. Other features, details, utilities, and advantages of the claimed subject matter will be apparent from the following written Detailed Description including those aspects illustrated in the accompanying drawings and defined in the appended claims.

### BRIEF DESCRIPTIONS OF THE DRAWINGS

The accompanying drawings, which are incorporated into and form a part of the specification, illustrate several implementations of the claimed invention, and, together with the description, serve to explain the principles of the invention. The drawings are only for the purpose of illustrating various exemplary implementations and are not to be construed as limiting the invention.

FIG. 1 is a plan view of the inside face of one implementation of a multi-compartmental medication organizer, fully extended, and in the process of being rolled up.

FIG. 2 is a plan view of the inside face of another implementation of a multi-compartmental medication organizer, fully extended (FIG. 2A), in the process of being folded (FIG. 2B), and completely folded (FIG. 2C).

FIG. 3 is a perspective view of yet another implementation of a multi-compartmental medication organizer.

FIG. 4 is a plan view of the inside face of yet another implementation of a multi-compartmental medication organizer, fully extended.

FIG. 5 is a plan view of a portion of the inside of a multi-compartmental medication organizer, where one of two compartment holders is removed from the organizer body.

FIG. 6 is a plan view of a portion of the inside portion of a multi-compartmental medication organizer, where the one compartment holder shown is removed from the organizer body, and where one of six compartments is removed from the compartment holder component.

FIG. 7 is a perspective view of a compartment holder component removed from the body of the organizer, and in the process of being rolled up.

FIGS. 8A through 8D are plan views of various implementations of compartment holders according to the claimed invention.

FIGS. 9A through 9C are plan views of the inside face of three other implementations of multi-compartmental medication organizers, fully extended.

### DETAILED DESCRIPTION

Technology is described herein for providing a multi-compartmental medication organizer that can be rolled or folded and “dissected” so that a user may take needed medications along with him or her as needed, while leaving unneeded medications behind. The multi-compartmental medication organizer allows for carrying medications needed for an extended period of time in an organized yet compact manner, while giving the option of easily carrying specific portions, regimens or subsets of the medication as desired.

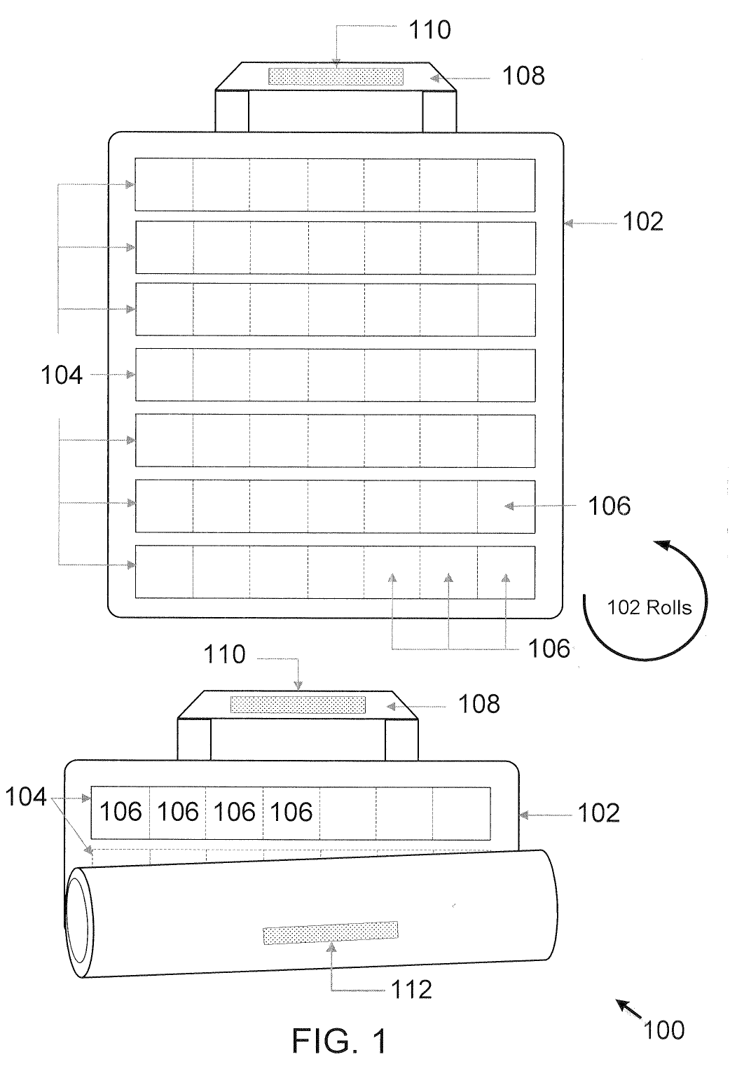

FIG. 1 is a plan view of the inside face of one implementation of a multi-compartmental medication organizer 100. The multi-compartmental medication organizer 100 comprises a body 102 with compartment holders 104 in the form of strips. The compartment holders 104 comprise a series of compartments 106 in which medications and supplements (not shown) are contained. The multi-compartmental medication organizer 100 also comprises a handle 108 from which the multi-compartmental medication organizer 100 may be hung, allowing one to view the entirety of the medication organizer and for ease in filling the medication organizer. The handle 108 may further comprise a fastener 110 of some type such as Velcro®. FIG. 1 further shows the multi-compartmental medication organizer 100 in the process of being rolled up. Again, the multi-compartmental medication organizer 100 comprises a body 102 with compartment holders 104 in the form of strips where the compartment holders 104 comprise a series of compartments 106. The multi-compartmental medication organizer 100 also comprises a reciprocal fastener 112 to mate with fastener 110 on handle 108 to retain the multi-compartmental medication organizer in the rolled configuration.

As can be seen in FIG. 1, the multi-compartmental medication organizer 100 may be rolled, folded or otherwise collapsed for traveling or storage; thus the multi-compartmental medication organizer 100 typically comprises soft or pliant materials such as fabric or cloth or pliant plastics or other polymers. The body 102, compartment holders 104 and compartments 106 may comprise the same material, or may comprise different materials. The multi-compartmental medication organizer may comprise any type of fabric, e.g., natural fabrics such as muslin, cotton, silk, wool, and the like, or manmade fabrics such as polyester, nylon, acrylic, polyurethane, olefin and the like and blends thereof. The material(s) chosen for the multi-compartmental medication organizer may in some implementations be washable; alternatively, in some implementations, one or more of the materials may be waterproof. The multi-compartmental medication organizer may in some implementations be highly decorative, and in other implementations may be primarily utilitarian. The fastener shown in FIG. 1 is a Velcro®-type fastener, but the fastener may be of any sort such as one or more snaps, hooks, magnets, zippers, buttons or ties. Alternatively, the multi-compartmental medication organizer 100 may not have a fastener at all.

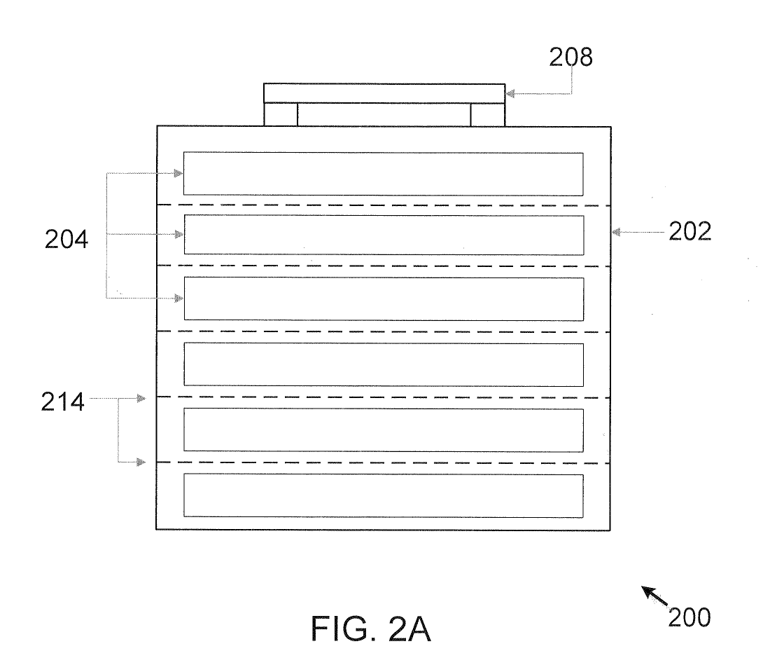

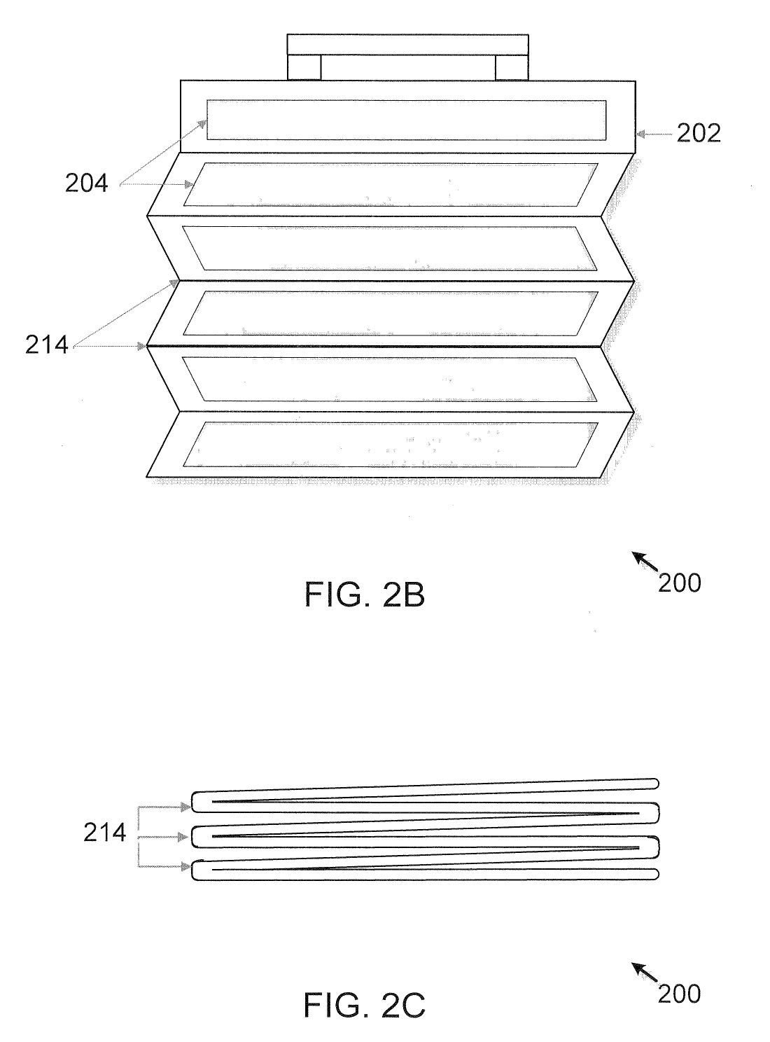

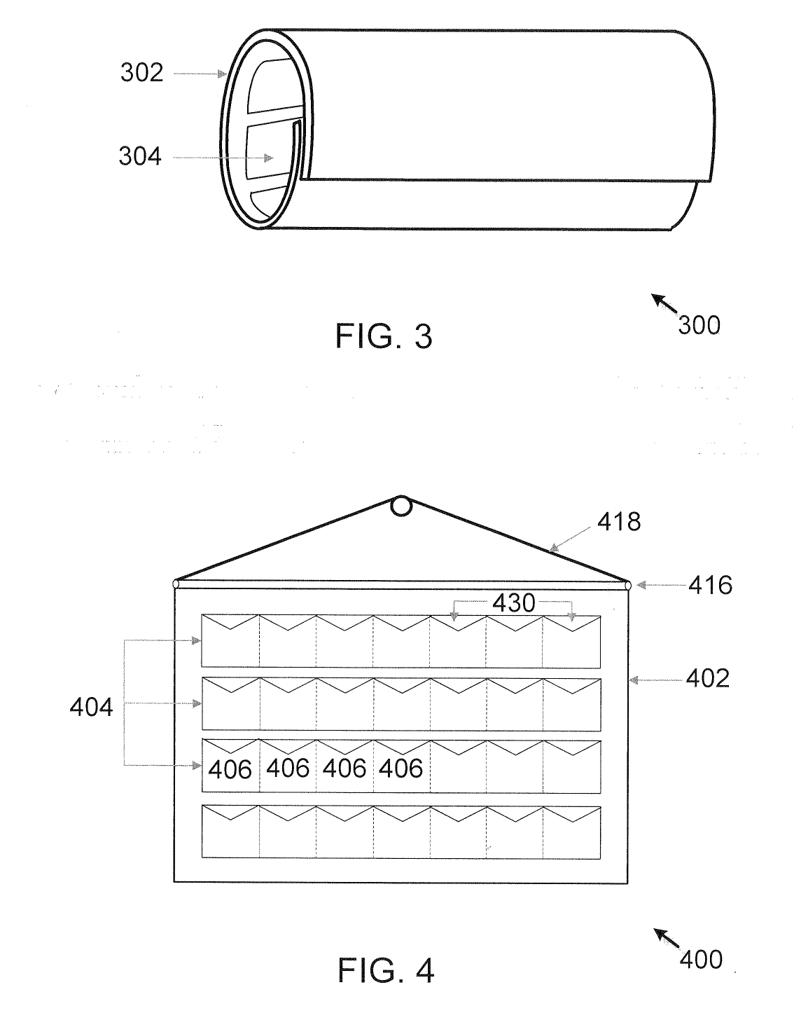

FIG. 2 is a plan view of the inside face of another implementation of a multi-compartmental medication organizer 200, fully extended (FIG. 2A), in the process of being folded (FIG. 2B), and completely folded (FIG. 2C). Again as shown in FIG. 1, the multi-compartmental medication organizer 200 comprises a body 202 with compartment holders 204 in the form of strips where the compartment holders 204 comprise a series of compartments. The multi-compartmental medication organizer 200 also comprises a handle 208. In addition, folds are seen at 214. The multi-compartmental medication organizer 200 in FIG. 2 is collapsed by folding rather than rolling, as seen in FIG. 2C. In some implementations, the body 202 of the multi-compartmental medication organizer 200 between the folds 214 may comprise a rigid or semi-rigid material to provide a degree of structural integrity as opposed to the substantially pliant multi-compartmental medication organizer shown in FIG. 1. FIG. 3 is a perspective view of yet another implementation of a multi-compartmental medication organizer 300, with a body 302 and compartment holders 304. The implementation shown in FIG. 3 is a tri-fold type format and may optionally comprise one or more fasteners where the body overlaps due to folding.

FIG. 4 is a plan view of the inside face of yet another implementation of a fully-extended multi-compartmental medication organizer 400. The multi-compartmental medication organizer 400 of FIG. 4 is similar to the multi-compartmental medication organizer 100 of FIG. 1, except that instead of a handle, the multi-compartmental medication organizer 400 has a solid tube support 416, through which a string 418 is passed to provide hanging capabilities. Again, the multi-compartmental medication organizer 400 comprises a body 402 with compartment holders 404 in the form of strips where the compartment holders 404 comprise a series of compartments 406. The compartments 406 are shown in more detail than in previous figures, as the compartments 406 comprise flaps 430. The flaps optionally may be secured by snaps, a Velcro®-type fastener or the like.

The format or configuration of the multi-compartmental medication organizer may vary as needed by a particular user. For example, the compartments may be used to hold a single type of medication or supplement; alternatively, the compartments may be used to hold the medications and/or supplements to be taken at a specific time, e.g., bedtime. In yet another alternative, each compartment may hold a day's medication. Similarly, each compartment holder may contain a day's medication in several compartments or a compartment holder may contain several days' medication (e.g., a compartment for each day of the week). Depending on the format or configuration of the compartments and compartment holders, a multi-compartmental medication organizer may contain medications and/or supplements for a week, a month or more. Additionally, certain implementations of the multi-compartmental medication organizer include various means to remind a user to take their supplements and/or medication (not shown). For example, a small, programmable electronic alarm may optionally be included with and affixed to the multi-compartmental medication organizer. Alternatively, the multi-compartmental medication organizer may include a memo pad (comprising paper, erasable plastic and the like) for the user to make notations and record reminders.

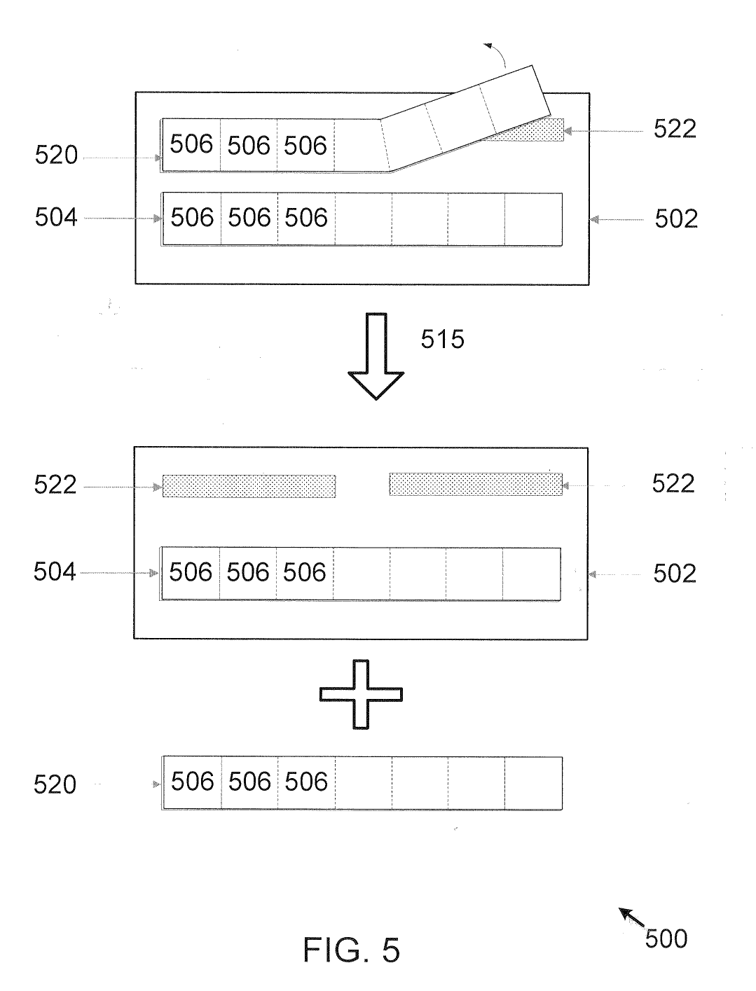

FIG. 5 is a plan view of a portion of the inside of a multi-compartmental medication organizer 500, where one of two compartment holders (520) is removed from the organizer body 502 while the other compartment holder 504 is left coupled to the body 502. Both compartment holders comprise compartments 506. However, FIG. 5 demonstrates how a compartment holder 520 can be de-coupled from the body 502 in process 515. Compartment holders that are to be de-coupled optimally comprise fasteners on the back of the compartment holder adjacent the facing side of the body 502, again, by snap or a Velcro®-type fastener, or by a zipper or hooks or the like. Here a Velcro®-type fastener 522 is shown. The removal of one compartment holder allows for a user to select a subset of medications to be removed from the multi-compartmental medication organizer for convenience. For example, if a user plans an overnight trip, the user can take only the medications needed for a 24 hour period, rather than having to take, e.g., a week's worth of medication. Thus, the present multi-compartmental medication organizer allows a user to select a portion of medication to be transported while maintaining the overall organization of the medication.

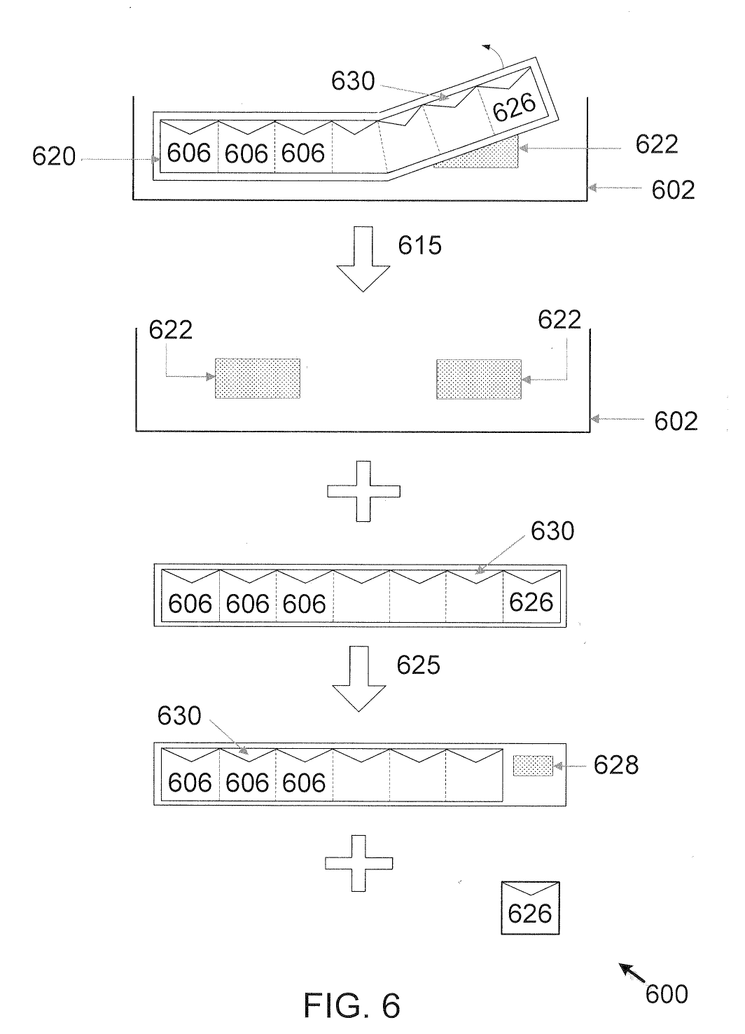

The versatility of the multi-compartmental medication organizer shown in FIG. 5 is taken a step further in the implementation shown in FIG. 6. FIG. 6 is a plan view of a portion of the inside portion of a multi-compartmental medication organizer 600, where the one compartment holder 620 is shown removed from the organizer body 602 in process 615, and where one (626) of the six compartments 606 is removed from the compartment holder 620 in process 625. Again, Velcro®-type fasteners 622 are shown which couple the compartment holder 620 to the body 602; however, in addition, a Velcro®-type fastener 628 is shown that serves to couple compartment 626 to the compartment holder 620. In such a case, if a user plans, for example, to be away from home only for one dosing period, the user can take only the medication needed for the one dosing period. Thus, the multi-compartmental medication organizer 600 shown in FIG. 6 provides maximum flexibility in organizing and transporting medication, allowing a user to carry a full organizer or to select a subset of the organized medication such as one or more compartment holders or simply one or more individual compartments.

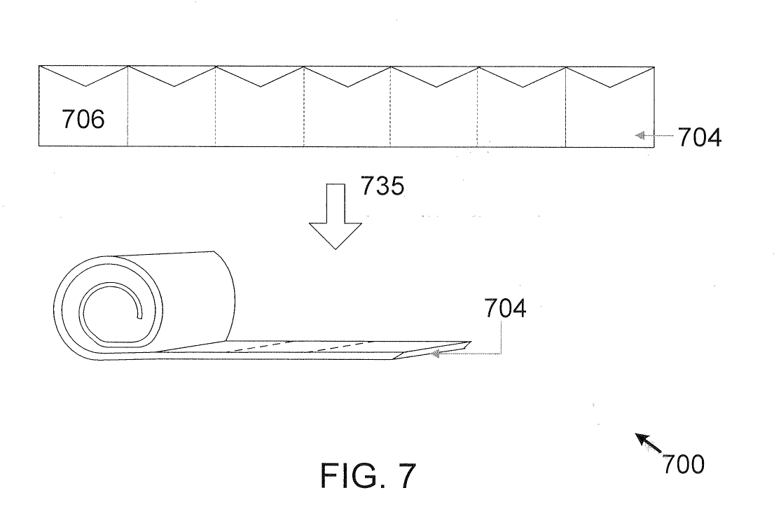

FIG. 7 is a perspective view of a compartment holder 704 comprising several compartments 706 removed from the body of an organizer, and in the process 735 of being rolled. Thus, like the multi-compartmental medication organizer itself, each compartment holder may be collapsed, rolled and/or folded to minimize storage space. Optionally in such a case, the compartment holder 704 may comprise one or more snaps, ties, buttons, hooks or the like to secure the compartment holder in a rolled or collapsed configuration.

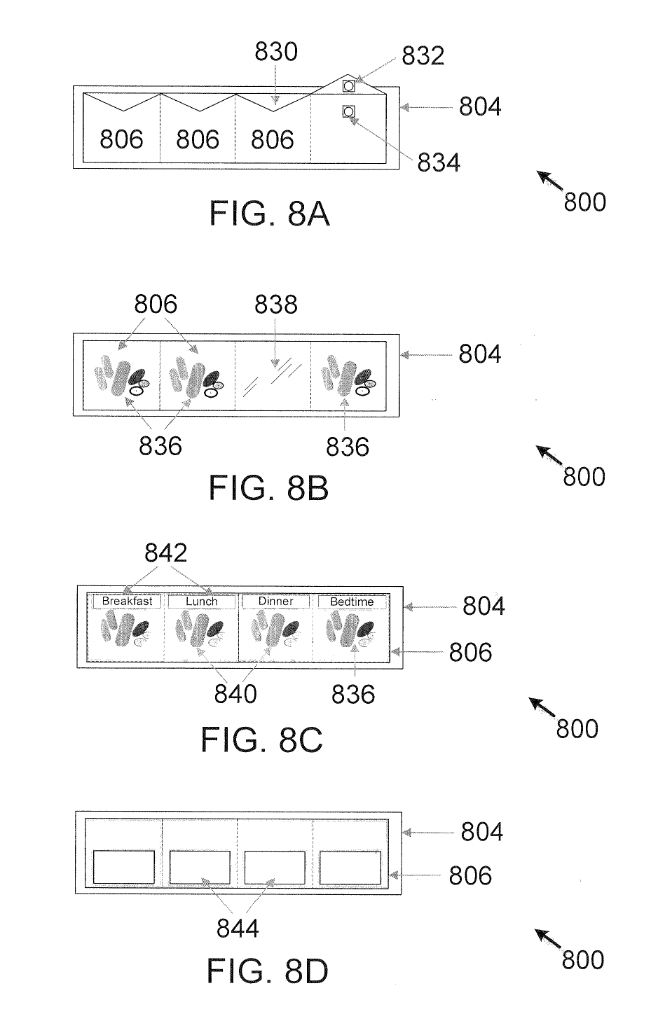

FIGS. 8A through 8D are plan views of various implementations of compartment holders 804 further demonstrating the versatility of the multi-compartmental medication organizer of the claimed invention. FIG. 8A shows a compartment holder 804 comprising four compartments 806, each having a flap 830. The leftmost compartment has the flap lifted to reveal fastener components 832 and 834. Again, the fasteners may be snaps, magnets, hooks, a “ziploc” type closure, a Velcro®-type fastener and the like. Alternatively, the compartments may be pleated, with elastic at the opening to provide closure of the compartment. The compartment holder 804 in FIG. 8B is an implementation where the front of each compartment 806 is clear plastic 838 revealing the medication contained therein (836). In this implementation, no fasteners are shown, though using fasteners in such implementations is an option. FIG. 8C illustrates yet another implementation of the compartment holders and compartments of the claimed invention. In FIG. 8C, compartments 806 comprise a clear window 840 through which medication 836 can be viewed, as well as labels 842. Labels 842 may be pre-made labels that are affixed to the compartments 806 or may be plastic tabs that can be written upon. In yet another implementation shown in FIG. 8D, the compartments may comprise clear plastic tabs behind which a label of the user's choosing can be placed. In some implementations, the multi-compartmental medication organizer may come with assorted pre-printed labels so that the user may customize the multi-compartmental medication organizer; alternatively, the multi-compartmental medication organizer may come in a kit comprising blank labels and a pen with which a user can customize the compartments.

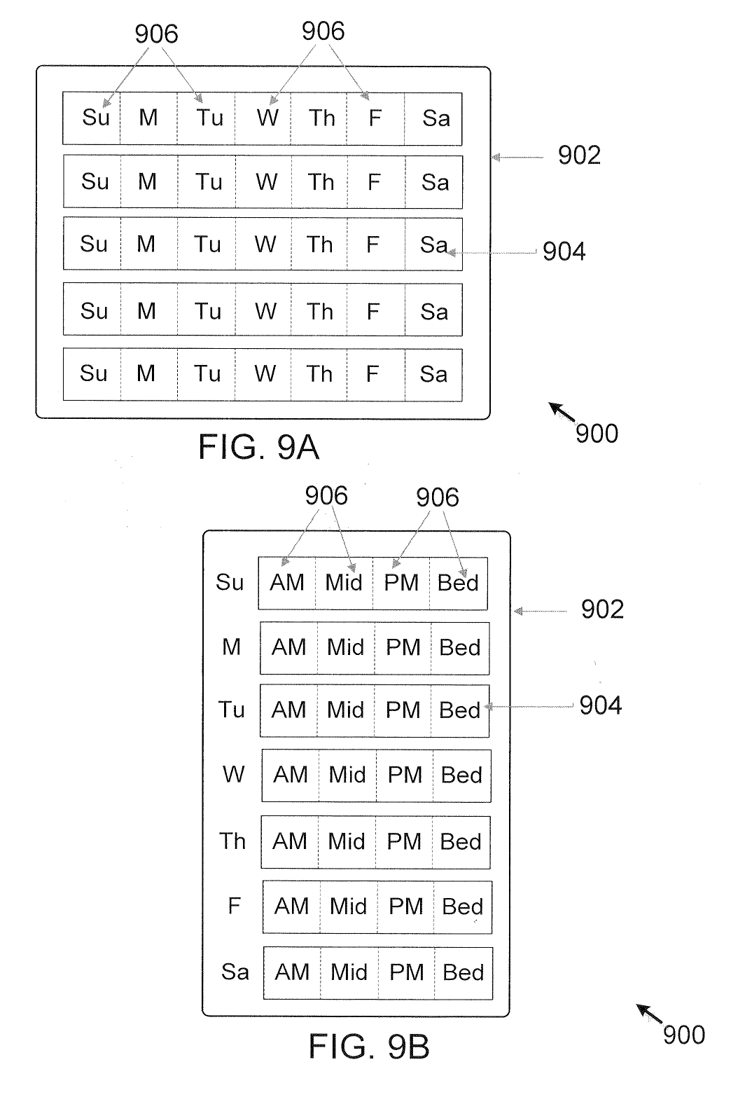

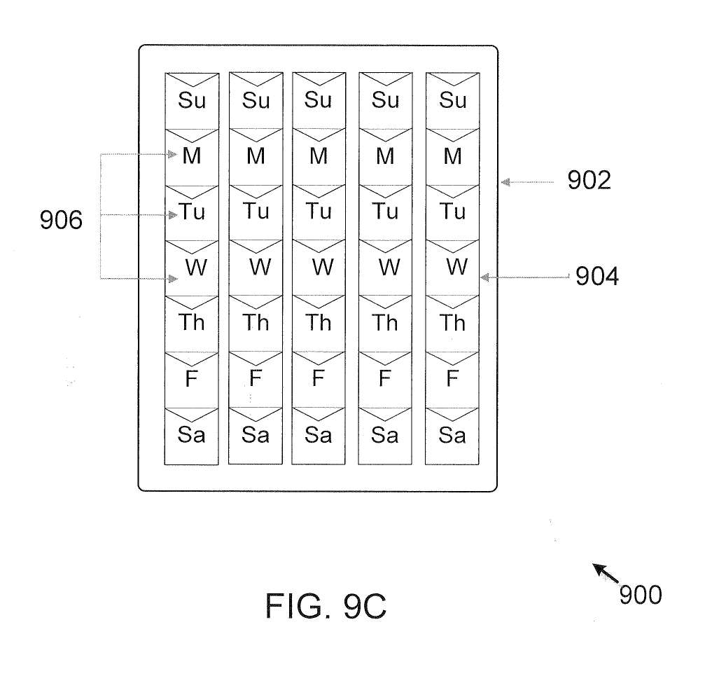

FIGS. 9A, 9B, and 9C are plan views of the inside face of yet three more fully-extended implementations of multi-compartmental medication organizers. The multi-compartmental medication organizer 900 seen in FIG. 9A comprises a body 902, compartment holders 904 and compartments 906. The implementation of the multi-compartmental medication organizer 900 seen here has a compartment 906 for each day of the week, and would hold five weeks' worth of medication. FIG. 9B shows a multi-compartmental medication organizer 900 with a body 902, seven compartment holders 904 and a multiplicity of compartments 906. The implementation of the multi-compartmental medication organizer 900 seen in FIG. 9B holds a weeks' worth of medication, with a compartment holder dedicated to each day of the week, and compartments dedicated to medication to be taken at specific times during the day. The multi-compartmental medication organizer illustrated in FIG. 9C has the compartment holders 904 affixed to the body 902 in a vertical rather than horizontal configuration, with accommodation for five weeks' worth of medications.

The present specification provides a description of the multi-compartmental medication organizers of the claimed invention as well as uses thereof. Although various aspects of this technology have been described above with a certain degree of particularity, or with reference to one or more individual aspects, those skilled in the art could make numerous alterations to the disclosed aspects without departing from the spirit or scope of the technology hereof. Since many aspects can be made without departing from the spirit and scope of the presently described technology, the appropriate scope resides in the claims hereinafter appended. Other aspects are therefore contemplated. It is intended that all matter contained in the above description and shown in the accompanying drawings shall be interpreted as illustrative only of particular aspects and are not limiting to the implementations shown. Changes in detail or structure may be made without departing from the basic elements of the present technology as defined in the following claims. In the claims, unless the term “means” is used, none of the features or elements recited therein should be construed as means-plus-function limitations pursuant to 35 U.S.C. §112, ¶6.

What is claimed is:

1. A multi-compartmental medication organizer comprising:
a substantially planar body constructed of a flexible material; and
a plurality of compartment holders detachably attached to a facing side of the body, wherein each compartment holder comprises a plurality of compartments large enough to hold several pills or supplements on a side of the compartment holder not attached to the body.

2. The multi-compartmental medication organizer of claim 1, wherein the plurality of compartments are detachably attached to the compartment holders.

3. The multi-compartmental medication organizer of claim 2, wherein the plurality of compartments is attached to the compartment holders by one or more Velcro®-type fasteners, snaps, hooks, magnets, Zilploc®-type fasteners, buttons or ties.

4. The multi-compartmental medication organizer of claim 1, wherein the compartment holders are attached to the body by one or more Velcro®-type fasteners, snaps, hooks, magnets, buttons or ties.

5. The multi-compartmental medication organizer of claim 1, further comprising a handle.

6. The multi-compartmental medication organizer of claim 1, further comprising a fastener capable of securing the multi-compartmental medication organizer in a collapsed configuration.

7. The multi-compartmental medication organizer of claim 6, wherein the fastener is one or more Velcro®-type fasteners, zippers, snaps, hooks, magnets, Zilploc®-type fasteners, buttons or ties.

9. The multi-compartmental medication organizer of claim 1, wherein the compartments comprise fasteners used to close the compartments.

10. The multi-compartmental medication organizer of claim 9, wherein the fastener is one or more Velcro®-type fasteners, snaps, hooks, magnets, buttons or ties.

11. The multi-compartmental medication organizer of claim 9, wherein the compartments further comprise a flap.

12. The multi-compartmental medication organizer of claim 9, wherein the compartments are pleated and an opening of the compartments comprises elastic.

13. The multi-compartmental medication organizer of claim 1, comprising four compartment holders wherein each compartment holder comprises seven compartments or comprising seven compartment holders wherein each compartment holder comprises four compartments.

14. The multi-compartmental medication organizer of claim 1, wherein the fabric is muslin, cotton, silk, wool, polyester, nylon, acrylic, polyurethane, olefin or blends thereof.

15. The multi-compartmental medication organizer of claim 1, wherein the body, compartment holders and compartments comprise fabric.

16. The multi-compartmental medication organizer of claim 1, further comprising means to remind a user to take medication.

17. A multi-compartmental medication organizer comprising:
a substantially planar body constructed of a flexible material; and
a plurality of compartment holders detachably attached to a facing side of the body, wherein each compartment holder comprises a plurality of detachably attached compartments each large enough to hold several pills or supplements on a side of the compartment holder not attached to the body.

18. The multi-compartmental medication organizer of claim 17, wherein the compartment holders are attached to the body by one or more Velcro®-type fasteners, snaps, hooks, magnets, Zilploc®-type fasteners, buttons or ties.

19. The multi-compartmental medication organizer of claim 17, wherein the compartments are attached to the compartment holders by one or more Velcro®-type fasteners, snaps, hooks, magnets, Zilploc®-type fasteners, buttons or ties.

20. The multi-compartmental medication organizer of claim 17, further comprising a fastener capable of securing the multi-compartmental medication organizer in a collapsed configuration.
